(19) United States
(12) Patent Application Publication
(10) Pub. No.: US 2026/0005612 A1
(43) Pub. Date: Jan. 1, 2026

(54) HIGH-PRECISION ISOLATION CONVERTER AND CONTROL METHOD THEREOF

(71) Applicant: Joulwatt Technology Co., Ltd., Hangzhou (CN)

(72) Inventors: Zhengxing LI, Hangzhou (CN); Changwei GONG, Hangzhou (CN)

(73) Assignee: Joulwatt Technology Co., Ltd., Hangzhou (CN)

(21) Appl. No.: 19/093,339

(22) Filed: Mar. 28, 2025

(30) Foreign Application Priority Data
Jun. 27, 2024 (CN) 202410842867.5
Aug. 20, 2024 (CN) 202411152972.2

(51) Int. Cl. H02M 3/335; H02M 3/00

(52) U.S. Cl. CPC H02M 3/33571; H02M 3/01

(57) ABSTRACT

A high-precision isolation converter and a control method thereof are provided. The isolation converter includes a half-bridge switching circuit, where when a switch tube in the half-bridge switching circuit is turned on, an excitation inductor, a resonant inductor, a resonant capacitor and the switch tube form a resonant network. A detection error amplifier circuit detects a node voltage of a high-potential end of a primary winding of a transformer to obtain a first detection signal representing output voltage information, and performs error amplification on the first detection signal and a preset reference voltage to obtain a compensation signal. A frequency and duty cycle adjustment circuit obtains a switching control signal according to the compensation signal, an inductor current sampling signal and a preset frequency signal to control a switching on and off of the half-bridge switching circuit, thereby controlling an output signal of the isolation converter to be stable.

### CROSS REFERENCE TO THE RELATED APPLICATIONS

This application is based upon and claims priority to Chinese Patent Application No. 202410842867.5, filed on Jun. 27, 2024, and Chinese Patent Application No. 202411152972.2, filed on Aug. 20, 2024, the entire contents of which are incorporated herein by reference.

### TECHNICAL FIELD

The present invention relates to the technical field of electronic circuits, and more particularly, to a high-precision isolation converter and a control method thereof.

### BACKGROUND

In power consumption fields such as new energy vehicles, new energy power generation, and server power supply, different power levels of power electronic converters will involve multiple voltage bus levels. Usually, isolation transmission is required between strong and weak electricity. With the development of the application of third-generation semiconductor materials, power electronics of power stage require higher switching frequencies. Increase in the switching frequency of the third-generation semiconductor requires smaller parasitic parameters of the isolated power supply to avoid strong interference to the driver chip, the isolation operational amplifier and the power devices. As a common topology of isolation converters, an Lr-Lm-Cr (LLC) flyback switching converter includes a resonant network formed by a resonant inductor, an excitation inductor and a resonant capacitor, so it is recorded as LLC flyback switching power supply. During the control process, its primary power tube can achieve zero voltage turn on, and the secondary rectifier tube can achieve zero current turn off. The inductance required for resonance is small, and the leakage inductance energy can be utilized, so the parasitic parameters are smaller than those of other topologies. Therefore, the LLC flyback switching converter is often used in isolated power supply scenarios for driver chip and isolated power supply.

However, if the prior LLC flyback switching converter is to achieve a stable power supply to the load, it needs to add external energy storage elements (transformers, inductors, capacitors, etc.) and components required for controlling the signals to form a circuit, so as to complete the power supply to the load. The prior LLC controller often adopts an open-loop control solution. After the driver sets the switching frequency/transformer parameters/resonant cavity parameters/secondary rectifier diode, the output voltage is greatly affected by these parameter ranges, and the output voltage has a large error, even up to several volts, affecting the precision and stability of the power supply.

The prior solution cannot meet the prior control requirements. Therefore, it is necessary to provide an improved technical solution to overcome the above technical problems in the prior art.

### SUMMARY

In view of the above, an objective of the present invention is to provide a high-precision isolation converter and a control method thereof, so as to solve the technical problem that the isolation converter in the prior art cannot precisely and stably provide the output voltage.

Provided is a high-precision isolation converter, and the isolation converter includes a half-bridge switching circuit, an excitation inductor, a resonant inductor and a resonant capacitor. When a switch tube in the half-bridge switching circuit is turned on, the excitation inductor, the resonant inductor, the resonant capacitor and the switch tube form a resonant network. The isolation converter includes a controller and a transformer. The controller includes a detection error amplifier circuit and a frequency and duty cycle adjustment circuit. The detection error amplifier circuit detects a node voltage of a high-potential end of a primary winding of the transformer to obtain a first detection signal representing output voltage information, and performs error amplification on the first detection signal and a preset reference voltage to obtain a compensation signal. The frequency and duty cycle adjustment circuit obtains a switching control signal according to the compensation signal and a preset frequency signal to control a switching on and off of the half-bridge switching circuit and control an output signal of the isolation converter to maintain stability.

Preferably, the resonant inductor and the resonant capacitor are connected in series to form a series branch, and the detection error amplifier circuit detects a voltage of an intermediate node of the series branch connected to the primary winding to obtain the first detection signal.

Preferably, during a conduction period of an upper switch tube or a conduction period of a lower switch tube of the half-bridge switching circuit, the detection error amplifier circuit obtains the first detection signal, where the first detection signal is linearly correlated with the output voltage information.

Preferably, the controller further includes a driving power circuit, and the driving power circuit receives the switching control signal for controlling a state of the half-bridge switching circuit to obtain a driving signal to drive the half-bridge switching circuit.

Preferably, the half-bridge switching circuit and the controller are integrated in a chip.

Preferably, the frequency and duty cycle adjustment circuit includes a resonant frequency setting circuit and a switching frequency generation circuit. The resonant frequency setting circuit obtains a frequency signal of a set frequency value through an external resistor of the controller and transmits the frequency signal to the switching frequency generation circuit. The switching frequency generation circuit receives the compensation signal and the frequency signal to generate the switching control signal, and transmits the switching control signal to the driving power circuit.

Preferably, the preset frequency signal includes a first frequency value and a second frequency value.

Preferably, the detection error amplifier circuit includes a first switch, a sample-and-hold circuit and an error amplifier circuit. A switching state of the first switch is consistent with a switching state of the upper switch tube of the half-bridge switching circuit. The sample-and-hold circuit samples and holds a voltage signal of a high-potential end of the primary winding when the first switch is turned on to obtain the first detection signal. The error amplifier circuit receives the first detection signal and the preset reference voltage and performs error amplification to obtain the compensation signal.

Preferably, the preset reference voltage is set according to the external resistor of the controller and is adjustable according to an output voltage of the isolation converter.

Preferably, the isolation converter is an LLC isolation converter.

Preferably, the controller further includes a protection and alarm circuit, and the protection and alarm circuit receives a circuit parameter to generate a protection and alarm signal, where the circuit parameter includes at least one of inductor current information, the first detection signal and chip temperature information.

In the second aspect, the present application also provides a control method for a high-precision isolation converter, where the isolation converter includes a half-bridge switching circuit, an excitation inductor, a resonant inductor and a resonant capacitor. When a switch tube in the half-bridge switching circuit is turned on, the excitation inductor, the resonant inductor, the resonant capacitor and the switch tube form a resonant network. The control method includes the steps of: detecting a node voltage of a high-potential end of a primary winding of a transformer during a conduction period of an upper switch tube or a conduction period of a lower switch tube of the half-bridge switching circuit to obtain a first detection signal representing output voltage information; performing error amplification on the first detection signal and a preset reference voltage to obtain a compensation signal; and obtaining a switching control signal according to the compensation signal, an inductor current sampling signal and a preset frequency signal to control a switching on and off of the half-bridge switching circuit and control an output signal of the isolation converter to maintain stability.

Preferably, the preset frequency signal includes a first frequency value and a second frequency value.

Preferably, when the upper switch tube is turned on, the voltage signal at the high-potential end of the primary winding is sampled and held to obtain the first detection signal; and error amplification is performed on the first detection signal and the preset reference voltage to obtain the compensation signal.

Preferably, the compensation signal and the preset frequency signal are received to generate the switching control signal; and the switching control signal passes through a driving circuit to obtain a driving signal to drive the half-bridge switching circuit.

The high-precision isolation converter and the control method thereof in the present invention are adopted, the isolation converter includes a half-bridge switching circuit, an excitation inductor, a resonant current, and a resonant capacitor. When a switch tube in the half-bridge switching circuit is turned on, the excitation inductor, the resonant inductor, the resonant capacitor and the switch tube constitute a resonant network. The detection error amplifier circuit detects the node voltage of the high-potential end of the primary winding of the transformer to obtain the first detection signal representing the output voltage information, and performs error amplification on the first detection signal and the preset reference voltage to obtain the compensation signal. The frequency and duty cycle adjustment circuit obtains the switching control signal according to the compensation signal and the preset frequency signal to control the switching on and off of the half-bridge switching circuit, thereby controlling the output signal of the isolation converter to maintain stability. Through the output voltage detection and feedback control of the present invention, the output of the LLC isolation converter is stable and not affected by a circuit parameter, with good feedback and high precision.

### BRIEF DESCRIPTION OF THE DRAWINGS

FIG. 1 is a circuit block diagram of an isolation converter according to the present invention;

FIG. 2 is a circuit block diagram of a controller according to FIG. 1;

FIG. 3 is an implemented circuit diagram of a frequency and duty cycle adjustment circuit according to FIG. 2;

FIG. 4 is an implemented circuit diagram of a detection error amplifier circuit according to FIG. 2;

FIG. 5 is an implemented circuit diagram of a driving power circuit according to FIG. 2; and

FIG. 6 is a working waveform diagram according to the present invention.

### DETAILED DESCRIPTION OF THE EMBODIMENTS

The preferred embodiments of the present invention are described in detail below in conjunction with the drawings, but the present invention is not limited to these embodiments. The present invention covers any substitution, modification, equivalent method and solution made within the spirit and scope of the present invention.

In order to enable the public to have a thorough understanding of the present invention, specific details are described in detail in the following preferred embodiments of the present invention, and those skilled in the art can fully understand the present invention without the description these details.

In the following paragraphs, the present invention is described in more detail by way of example with reference to the drawings. It should be noted that the drawings are all in a relatively simplified form and are not in precise proportions, and are only used to conveniently and clearly assist in explaining the purpose of the embodiments of the present invention.

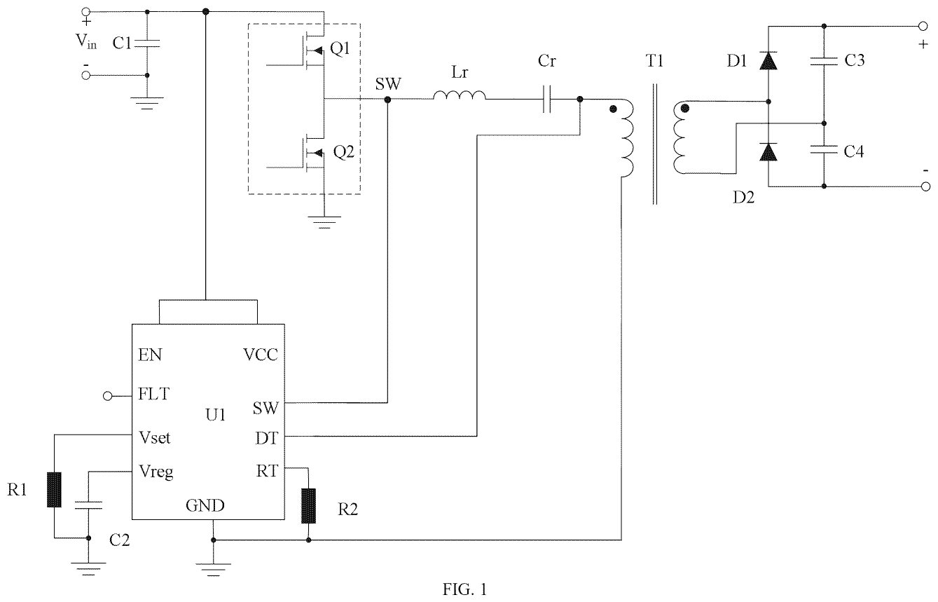

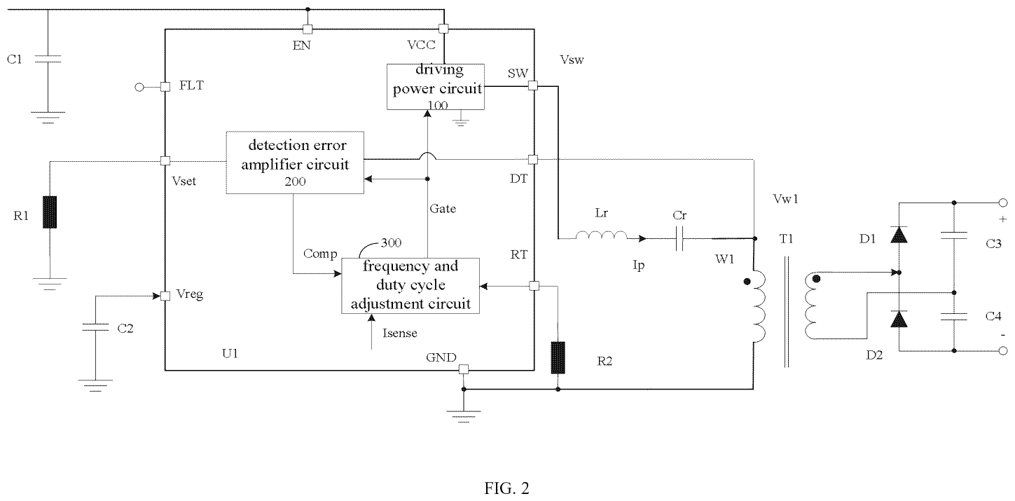

As reference, FIG. 1 is a circuit block diagram of an isolation converter according to the present invention, and FIG. 2 is a circuit block diagram of a controller according to FIG. 1. The isolation converter of an embodiment of the present invention is an LLC isolation converter, and the isolation converter includes a half-bridge switching circuit, an excitation inductor, a resonant inductor and a resonant capacitor. When one of the switch tubes in the half-bridge switching circuit is turned on, the excitation inductor, the resonant inductor, the resonant capacitor and the switch tube constitute a resonant network. For example, the half-bridge switching circuit includes a switch tube Q1 and a switch tube Q2. In this embodiment, the excitation inductor such as Lm is included in a primary winding of a transformer. When the switch tube Q1 is turned on, the resonant inductor Lr, the excitation inductor Lm, the resonant capacitor, the switch tube Q1 and two input ends of the input voltage constitute a resonant network. When the switch tube Q2 is turned on, the excitation inductor Lr, the excitation inductor Lm, the resonant inductor Lr, the excitation inductor Lm, the resonant capacitor and the switch tube Q2 constitute a resonant network. The LLC isolation converter receives an input voltage Vin and converts it into a desired output voltage Vout through a switching on and off of the half-bridge switching circuit to supply power to a load.

Specifically, as shown in FIG. 2, the controller includes a detection error amplifier circuit, a frequency and duty cycle adjustment circuit and a driving power circuit. The detection error amplifier circuit detects the node voltage of the high-potential end of the primary winding of the transformer, such as the voltage of the W1 node, to obtain a first detection signal representing the output voltage information. Specifically, the resonant inductor Lr and the resonant capacitor Lc are connected in series to form a series branch, and the detection error amplifier circuit detects a voltage of the intermediate node of the series branch connected to the primary winding to obtain the first detection signal. After that, the compensation signal comp is obtained by performing error amplification on the first detection signal and a preset reference voltage Vref. The frequency and duty cycle adjustment circuit obtains a switching control signal according to the compensation signal comp and the preset frequency signal fr, and the driving power circuit receives the switching control signal Gate that controls a state of the half-bridge switching circuit to obtain a driving signal to drive the half-bridge switching circuit. Here, taking the half-bridge switching circuit and the controller integrated in a chip as an example, the half-bridge switching circuit can include transistors or triodes such as switch tubes.

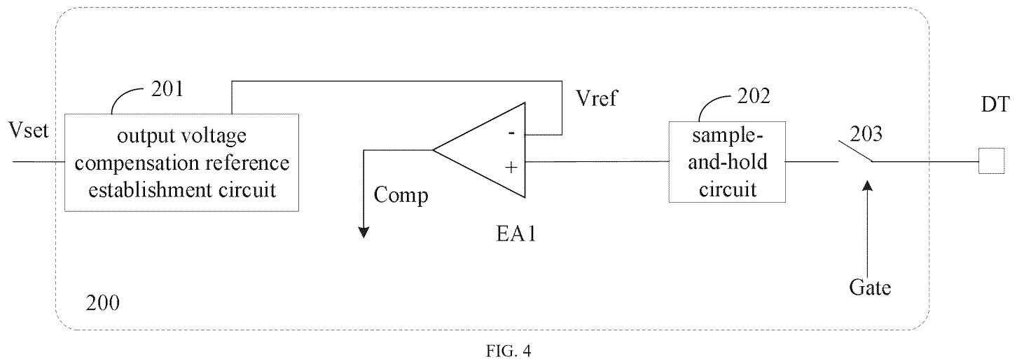

Here, during the conduction period of the upper switch tube Q1 of the half-bridge switching circuit, the detection error amplifier circuit obtains the first detection signal, where the first detection signal is linearly correlated with the output voltage information. Here, when the switch tube Q1 is turned on, through the turns ratio relationship between the primary and secondary windings of the transformer, since the secondary winding of the transformer is associated with the output voltage, the high-potential end voltage of the primary winding can be obtained by calculation, and thus, the first detection signal and the output voltage information are also in a certain proportional relationship. Similarly, during the conduction period of the lower switch tube, the voltage sampled during the conduction time of the lower switch tube is a negative voltage, and then a positive voltage signal is obtained by voltage conversion. Specifically, referring to FIG. 4, the detection error amplifier circuit 200 includes a first switch 203, a sample-and-hold circuit 202, and an error amplifier circuit EA1, where the switching state of the first switch is consistent with the switching state of the upper switch tube Q1 of the half-bridge switching circuit. The sample-and-hold circuit samples and holds the voltage signal at the high-potential end of the primary winding when the first switch is turned on to obtain the first detection signal. The error amplifier circuit receives the first detection signal and the preset reference voltage Vref and performs error amplification to obtain the compensation signal Comp. Here, the detection error amplifier circuit 200 further includes an output voltage compensation reference establishment circuit 201, which is externally connected to a resistor to generate the preset reference voltage Vref. According to the resistance value adjustment of the resistor, the preset reference voltage Vref can be adjusted accordingly. If the resistance value of the resistor changes according to the output voltage, the preset reference voltage Vref can be adjusted according to the output voltage.

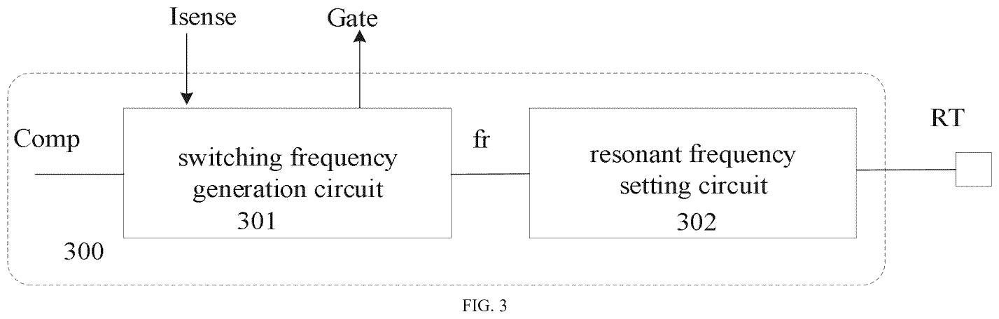

Specifically, as shown in FIG. 3, the frequency and duty cycle adjustment circuit 300 includes a resonant frequency setting circuit 302 and a switching frequency generation circuit 301. The resonant frequency setting circuit obtains a frequency signal fr of a set frequency value through a resistor outside the controller and transmits the frequency signal fr to the switching frequency generation circuit. The switching frequency generation circuit receives the compensation signal Comp. The switching frequency generation circuit generates the switching control signal Gate according to the compensation signal and the frequency signal and transmits the switching control signal Gate to the driving power circuit. The preset frequency signal includes a first frequency value and a second frequency value. Specifically, the preset frequency value is set according to the external resistor of the controller, and can also be adjusted according to the output voltage of the isolation converter. Specifically, the switching frequency generation circuit can adjust the working time of the main switch tube Q1 through the compensation signal to adjust the working frequency of the system so that the working frequency of the system is consistent with the frequency signal fr of the frequency value. Here, the frequency and duty cycle adjustment circuit 300 can also receive the inductor current sampling signal Isense, and then adjust the duty cycle according to the inductor current sampling signal to achieve overcurrent protection of the current.

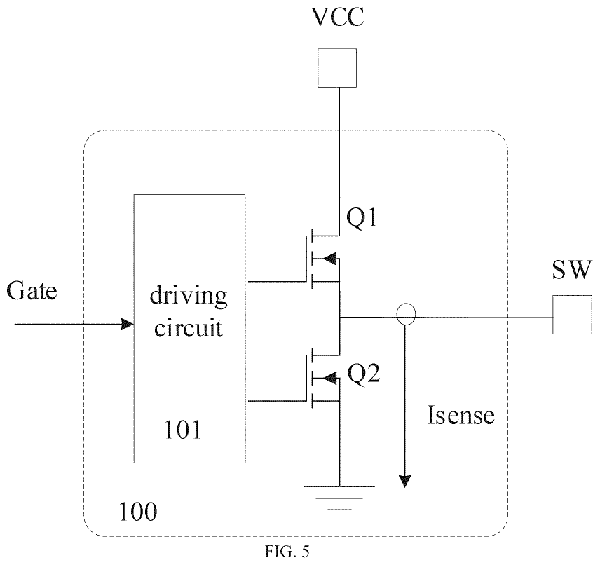

As shown in FIG. 5, the controller further includes the driving power circuit 100, and the driving power circuit 100 includes a driving circuit 101 and half-bridge switching circuits Q1 and Q2. The driving power circuit receives a switching control signal for controlling the state of the half-bridge switching circuit to obtain a driving signal to drive the half-bridge switching circuit. A power terminal of the switch tube Q1 is connected to the power supply voltage Vcc, and a power terminal of the other switch tube is connected to the reference ground. A common node of the half-bridge switching circuits Q1 and Q2 is connected to the series branch of the resonant inductor and the resonant capacitor. The half-bridge switching circuit and the controller are integrated in a chip to make the circuit more integrated and optimize the volume.

In addition, the controller further includes a protection and alarm circuit, and the protection and alarm circuit receives a circuit parameter to generate a protection and alarm signal, where the circuit parameter includes at least one of inductor current information, the first detection signal and chip temperature information. Through the protection and alarm circuit, the controller can timely control the switch tube to be turned off in an emergency to protect the safe operation of the controller.

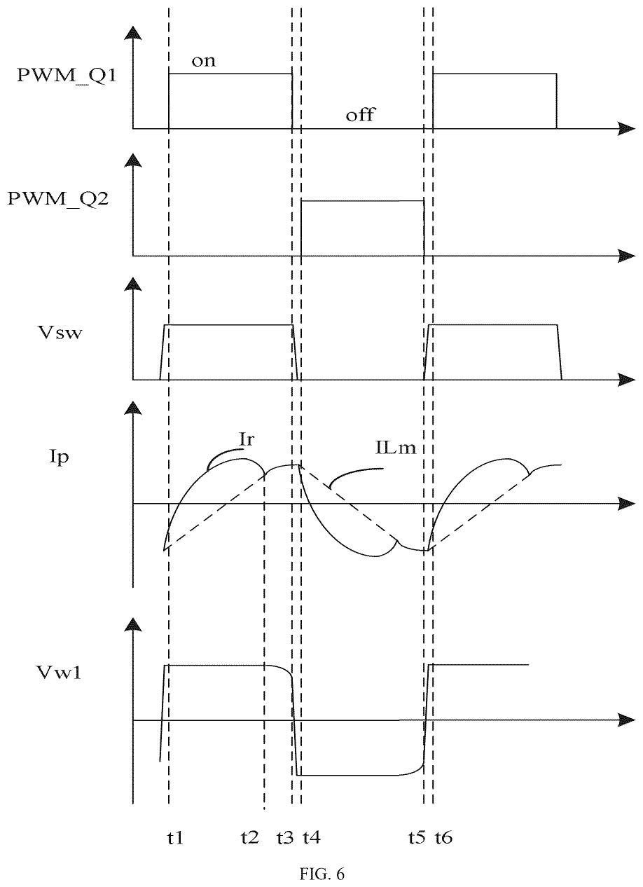

Referring to FIG. 6, which is a working waveform diagram according to the present invention, at time t1, the driving signal PWM_Q1 of the upper switch tube Q1 of the half-bridge switching circuit becomes a high effective state, the upper switch tube Q1 is turned on, the voltage V_{SW} of the common node of the half-bridge switching circuit Q1 and Q2 also starts to rise, the resonant current Ir rises, and the excitation current ILm also rises, and the high-potential end voltage V_{W1} of the primary winding gradually rises to a stable value, where the stable value is associated with the output voltage information. At this time, the output voltage information is obtained through the detection of the detection error amplifier circuit, and is fed back to the frequency and duty cycle adjustment circuit to control the duty cycle of the switch tube, so that the output voltage value is consistent with the preset reference voltage. Afterwards, at time t2, the resonant current Ir is equal to the excitation current ILm, and the current of the first diode DI of the secondary side is reduced to zero, thereby realizing zero current switching-off ZCS. Until time t3, the resonant inductor Lr, the resonant capacitor Cr and the excitation inductor of the first transformer Tl of the primary side are connected in series to obtain a longer period of resonance. At t3, the driving power circuit 100 drives the upper switch tube to be turned off, and the resonant current Ir is still positive, releasing the charge of the parasitic capacitor of the V_{SW} node so that V_{SW} is reduced to zero, until t4 when the driving power circuit 100 drives the lower switch tube Q2 to realize zero voltage switching-on ZVS.

Through the above process, it can be seen that the present application can achieve zero current switching-off of the secondary side and zero voltage switching-on of the primary side, and can also realize the feedback of the output voltage information of the secondary side to the primary side, so as to precisely control the output voltage magnifitude of the secondary side. For example, when a disturbance such as a load change or a change in the power supply voltage Vcc enters the circuit, assuming that the output voltage Vout is higher than the preset value, the corresponding node voltage V_{SW1} in the t1-t2 period is also higher than the set value, and after passing through the sample-and-hold circuit 202, the output compensation signal Comp of the first error amplifier EA1 begins to increase, and the gate signal frequency output by the switching frequency generation circuit 301 is positively correlated with the compensation signal Comp, that is, the Gate signal frequency also increases. As is known to all, the LLC topology works normally in the inductive region, and the gain of the output voltage Vout is negatively correlated with the switching frequency. The increase in the Gate signal frequency causes the output voltage Vo to decrease, so that in a disturbance that the output voltage Vout is higher than the set value, the closed-loop control output voltage Vout is adjusted down to the set value. Similarly, if the output voltage Vout is subjected to a disturbance regarding the decrease, the closed-loop regulation method is in a dual relationship with the above, and will not be repeatedly described here. Therefore, the control circuit can realize the closed-loop control of the LLC topology isolated power supply.

Finally, the present application provides a control method for a high-precision isolation converter, where the isolation converter includes a half-bridge switching circuit, an excitation inductor, a resonant inductor, and a resonant capacitor. When one of the switch tubes in the half-bridge switching circuit is turned on, the excitation inductor, the resonant inductor, the resonant capacitor and the switch tube form a resonant network. The control method includes the steps of:
detecting a node voltage of a high-potential end of a primary winding of a transformer during a conduction period of an upper switch tube of the half-bridge switching circuit to obtain a first detection signal representing output voltage information; performing error amplification on the first detection signal and a preset reference voltage to obtain a compensation signal; and obtaining a switching control signal according to the compensation signal, an inductor current sampling signal and a preset frequency signal to control a switching on and off of the half-bridge switching circuit and control an output signal of the isolation converter to maintain stability.

Preferably, the preset frequency signal includes a first frequency value and a second frequency value.

Preferably, when the upper switch tube is turned on, the voltage signal at the high-potential end of the primary winding is sampled and held to obtain the first detection signal; and the compensation signal is obtained by performing error amplification on the first detection signal and the preset reference voltage.

Preferably, the compensation signal and the inductor current sampling signal are received and compared with each other to obtain a comparison signal, and the switching control signal is generated according to the comparison signal and the preset frequency signal; and the switching control signal passes through a driving circuit to obtain a driving signal to drive the half-bridge switching circuit.

In summary, through the output voltage detection and feedback control of the LLC isolation converter of the present invention, the output of the LLC isolation converter is stable, not affected by a circuit parameter, with good feedback and high precision, which further improves the working efficiency.

It should be noted that the specific implementation and the corresponding illustrations given are only a way to describe the implementation method of the present invention, and do not limit the specific structure of the implementation solution of the present invention. Without departing from the principle and essence of the present invention, various changes or modifications can be made to these implementation solutions, but these changes and modifications shall fall within the scope of protection of the present invention.

Although the above embodiments are described and explained separately, some common technologies involved, in the opinion of ordinary technicians in this field, can be replaced and integrated between the embodiments. If the content is not clearly recorded in one of the embodiments, another embodiment with records can be referred to.

The above-mentioned implementation solution does not constitute a limitation on the scope of protection of the technical solution. Any modifications, equivalent replacements and improvements made within the spirit and principles of the above-mentioned implementation solutions should be included in the scope of protection of the technical solution.

What is claimed is:

1. A high-precision isolation converter, comprising a half-bridge switching circuit, an excitation inductor, a resonant inductor, a resonant capacitor, a controller and a transformer, wherein when a switch tube in the half-bridge switching circuit is turned on, the excitation inductor, the resonant inductor, the resonant capacitor and the switch tube form a resonant network; and the controller comprises a detection error amplifier circuit and a frequency and duty cycle adjustment circuit;
the detection error amplifier circuit detects a node voltage of a high-potential end of a primary winding of the transformer to obtain a first detection signal representing output voltage information, and performs an error amplification on the first detection signal and a preset reference voltage to obtain a compensation signal; and
the frequency and duty cycle adjustment circuit obtains a switching control signal according to the compensation signal and a preset frequency signal to control a switching on and off of the half-bridge switching circuit and control an output signal of the high-precision isolation converter to maintain stability.

2. The high-precision isolation converter according to claim 1, wherein the resonant inductor and the resonant capacitor are connected in series to form a series branch, and the detection error amplifier circuit detects a voltage of an intermediate node of the series branch connected to the primary winding to obtain the first detection signal.

3. The high-precision isolation converter according to claim 1, wherein during a conduction period of an upper switch tube of the half-bridge switching circuit or a conduction period of a lower switch tube of the half-bridge switching circuit, the detection error amplifier circuit obtains the first detection signal,
wherein the first detection signal is linearly correlated with the output voltage information.

4. The high-precision isolation converter according to claim 1, wherein the controller further comprises a driving power circuit, and
the driving power circuit receives the switching control signal to obtain a driving signal to drive the half-bridge switching circuit.

5. The high-precision isolation converter according to claim 1, wherein the half-bridge switching circuit and the controller are integrated in a chip.

6. The high-precision isolation converter according to claim 4, wherein the frequency and duty cycle adjustment circuit comprises a resonant frequency setting circuit and a switching frequency generation circuit, wherein
the resonant frequency setting circuit obtains a frequency signal with a set frequency value through an external resistor of the controller and transmits the frequency signal to the switching frequency generation circuit; and
the switching frequency generation circuit generates the switching control signal according to the compensation signal and the frequency signal and transmits the switching control signal to the driving power circuit.

7. The high-precision isolation converter according to claim 6, wherein the preset frequency signal comprises a first frequency value and a second frequency value.

8. The high-precision isolation converter according to claim 1, wherein the detection error amplifier circuit comprises a first switch, a sample-and-hold circuit and an error amplifier circuit, wherein
a switching state of the first switch is consistent with a switching state of an upper switch tube of the half-bridge switching circuit;
the sample-and-hold circuit samples and holds a voltage signal of the high-potential end of the primary winding when the first switch is turned on to obtain the first detection signal; and
the error amplifier circuit receives the first detection signal and the preset reference voltage and performs the error amplification to obtain the compensation signal.

9. The high-precision isolation converter according to claim 1, wherein the preset reference voltage is set according to an external resistor of the controller and is adjustable according to an output voltage of the high-precision isolation converter.

10. The high-precision isolation converter according to claim 1, wherein the high-precision isolation converter is an Lr-Lm-Cr (LLC) isolation converter.

11. The high-precision isolation converter according to claim 1, wherein the controller further comprises a protection and alarm circuit, wherein
the protection and alarm circuit receives a circuit parameter to generate a protection and alarm signal; and
the circuit parameter comprises at least one of inductor current information, the first detection signal and chip temperature information.

12. A control method for a high-precision isolation converter, wherein the high-precision isolation converter comprises a half-bridge switching circuit, an excitation inductor, a resonant inductor and a resonant capacitor; when a switch tube in the half-bridge switching circuit is turned on, the excitation inductor, the resonant inductor, the resonant capacitor and the switch tube form a resonant network; and the control method comprises steps of:
detecting a node voltage of a high-potential end of a primary winding of a transformer during a conduction period of an upper switch tube or a conduction period of a lower switch tube of the half-bridge switching circuit to obtain a first detection signal representing output voltage information;
performing an error amplification on the first detection signal and a preset reference voltage to obtain a compensation signal; and
obtaining a switching control signal according to the compensation signal, an inductor current sampling signal and a preset frequency signal to control a switching on and off of the half-bridge switching circuit and control an output signal of the high-precision isolation converter to maintain stability.

13. The control method of the high-precision isolation converter according to claim 12, wherein the preset frequency signal comprises a first frequency value and a second frequency value.

14. The control method of the high-precision isolation converter according to claim 12, wherein when the upper switch tube is turned on, a voltage signal at the high-potential end of the primary winding is sampled and held to obtain the first detection signal; and
the error amplification is performed on the first detection signal and the preset reference voltage to obtain the compensation signal.

15. The control method of the high-precision isolation converter according to claim 12, wherein the compensation signal and the preset frequency signal are received to generate the switching control signal; and
the switching control signal passes through a driving circuit to obtain a driving signal to drive the half-bridge switching circuit.
